(19) United States
(12) Patent Application Publication
(10) Pub. No.: US 2025/0279879 A1
(43) Pub. Date: Sep. 4, 2025

(54) Proof of Entanglement and Cipher that Carries its own Key

(71) Applicants: Hamid Pishdadian, Warwick, RI (US); Akram Khalis, Roselle, NJ (US)

(72) Inventors: Hamid Pishdadian, Warwick, RI (US); Akram Khalis, Roselle, NJ (US)

(21) Appl. No.: 18/885,651

(22) Filed: Sep. 14, 2024

Related U.S. Application Data
(60) Provisional application No. 63/526,842, filed on Jul. 14, 2023.

(51) Int. Cl. H04L 9/08; G06K 19/06; H04L 9/32

(52) U.S. Cl. CPC H04L 9/0819; H04L 9/3218; G06K 19/06037

(57) ABSTRACT

What is being presented is Proof of Entanglement (PoE), an algorithmic interchange of information that removes the need for classical consensus when adding blocks to a blockchain through its inherent ability to entangle the source of a document (sender) to the consumer of the document (receiver). The presented method and algorithm will ensure that only the intended receiver can possibly receive and be able to decrypt the document. Furthermore, PoE will guarantee the authenticity and security of the document to a level of entropy that will take more computational energy than is available on Earth to decipher, using today's supercomputers. PoE will create a quantum link (shared encryption key) between the sender and receiver. This key is used for document encryption and decryption but is never sent from the sender to the receiver. It is generated by the platform's servers and link devices (LINK) for both the representative of the sender and the representative of the receiver. This encryption key is produced by data held in the LINK that provides secure data to their counterpart entangled node devices (NODE). These in turn create the actual block of the blockchain. FIG. 1 is the block diagram of the platform. It consists of the following servers, LINK, and NODE. The NODE and LINK are held by people and/or businesses that support the platform. The platform description will clarify some of the complexities associated with the model.

### BACKGROUND OF THE INVENTION

Blockchains have been in existence for many years; but their applications have flourished since the rise of Bitcoin and Ethereum networks, as well as other discoveries and innovations. Today, blockchains are used for storing secure transactions, holding user information, over-the-border currency transfer, distributed applications, financial technologies, and many other services. Proof of Work (PoW) is the mechanism by which many of these blockchains verify the authenticity of the transactions in order to come to a consensus among chain holders. The problem with PoW is the energy required to secure the transactions. A typical PoW consensus will consume as much as 1449 KWH of power. That is roughly the same power to energize 300 homes in the USA. Proof of Stake (POS) is the second most popular consensus mechanism. PoS uses much less power than PoW, but it is still substantial. There are other methods of consensus that perform better than PoW and PoS, but there are structural problems with all of them. To make blockchain technology what it promises to be requires a method of consensus that is fast, reliable, uses minimal energy, and—above all—is very secure. In the abstract portion of this application, we will introduce a mechanism that creates a communication scheme that achieves all of these requirements.

### PLATFORM DESCRIPTION

The underlying platform that runs PoE consists of the following servers and characteristics:

NODE: These hardware devices hold the blockchain.

LINK: The link between cloud servers and NODE. LINK and NODE use Simulated Quantum Entanglement to communicate. US patent publication number: 20220385472

Client servers: Entry points for all mobile devices connected to these servers.

API servers: Entry point for all non-mobile devices into the platform.

Link servers: These servers are the hubs for all LINKs and NODEs. LINK servers do the computation to be used in verification and verify user IDs, known as SQid. They also are the bridge that links the representatives of senders to the representative of the receivers.

Cloud database servers: Database servers hold the encrypted user data.

Dispatch servers: Hubs for all servers to communicate using PoE for security.

Audit servers: These servers communicate with NODEs and database servers to get information about all activities on the platform. They also publish the platform's main blockchain.

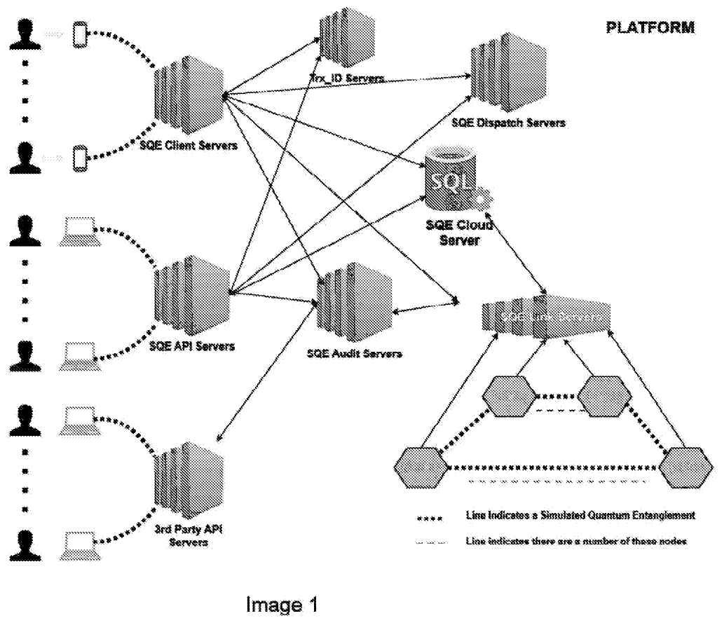

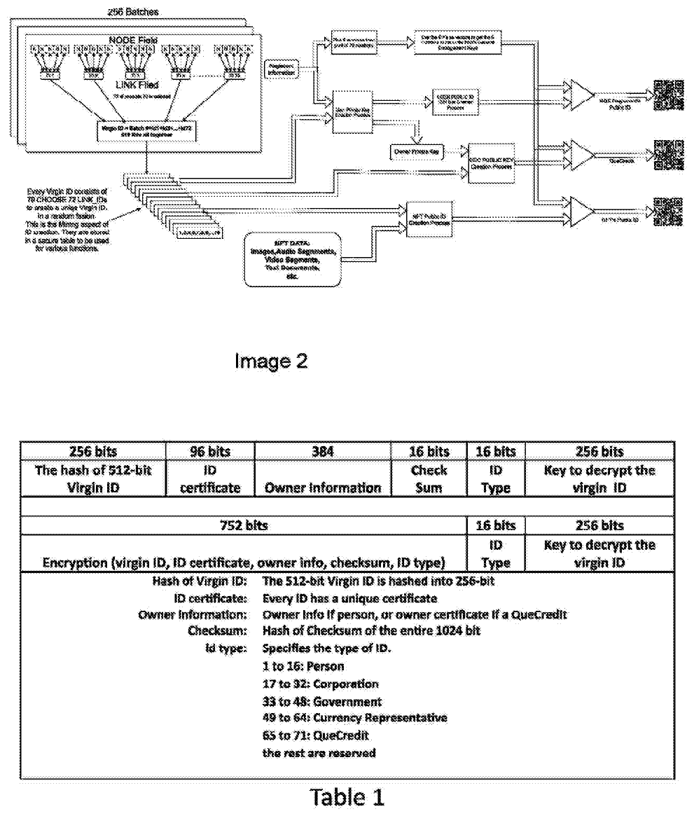

Virgin ID (Vid): As shown in FIG. 2, there are a total of 79 types of LINKs and a number of NODES that are associated with each LINK. There can be as many as 256 batches of these NODEs. Every Vid contains a set of (79 CHOOSE 72) possible LINK identifiers. A set of these ids is called Virgin ID. LINK IDs range from 1 to 79, therefore 7 bits are needed to represent each LINK ID. Therefore, the Vid is made of 7×72+8 or 512 bits. The value 8 represents the batch number that the Vid belongs to. Vid is used to specify an entity on the platform.

User ID (SQid): The heart of PoE is the identification code assignment to users who wish to use the platform. As shown in Table 1, SQid consists of various elements. It carries its own key that is used to verify its authenticity. It is a 1024-bit number with 256-bit as the key. This key is generated by parameters that are kept securely in the LINK devices. The Vid along with other private information associated with any given user is combined and hashed as part of the SQid. During the deciphering process, the key is used to decrypt the information kept in the cloud database that is assigned to the user associated with an SQid. Only the LINK devices hold the information required to produce the key and decrypt the data, which holds the actual Vid of the user. The following mathematical relationships denote this process. LINK devices contain several parameters:
P: a randomly assigned 32-bit prime number: P<(2³²−1)
A: a randomly assigned 32-bit integer.
B: a randomly assigned 32-bit integer.
C: a randomly assigned 32-bit integer.
D: a randomly assigned 32-bit integer.
   ID={1, 2, 3, . . . 79} Set of first 79 integers.
   Vid is a unique subset of LINK IDs {72, 79}
   Nid is a unque subset of LINK IDs {7, 79}
   Vid intersect Nid={ }
   The intersection of Vid and Nid is an empty set.
   Let's name the members of Nid set L1 to L7
   Nid={L1, L2, L3, L4, L5, L6, L7}

Each member of the Nid set includes the following parameters:
P, A, B, C, D. Specifically, P1, A1, B1, C1, D1 to P7, A7, B7, C7, D7.

C and D parameters are randomly selected aliases of P and B parameters:

The database encryption key for a given Vid is calculated as follows:

$$K 0 = 1 \\ K 1 = ( P 1 \times K 0 + A 1 ) xor B 1 \\ K 2 = ( P 2 \times K 1 + A 2 ) xor B 2$$

### Continue for all 7 LINKs.

$$K 7 = ( P 7 \times K 6 + A 7 ) xor B 7 \\ IDKEY = K 7$$

IDKEY is the actual key that is included as part of SQid. The maximum size of the IDKEY is 2^{32*7or 224}.

The IDKEY is padded to 256 bits.

### Encryption Key Generation to Encrypt the Document:

The Encryption Key is calculated based on the C and D parameters as follows:

$$E 0 = 1 \\ E 1 = C 0 \times E 0 + D 1 \\ E 2 = C 1 \times E 1 + D 2$$

### Continue for all 7 LINKs.

$$E 7 = C 7 \times E 6 + D 7 \\ Kenc = E 7$$

Since the actual values of C and D are never published or transmitted and have no mathematical relationship to counterparts P and A, there is no way to discover Kenc due to IDKEY. However, with an IDKEY (Key), one can find whether a given LINK is one of the contributors to the Key value. This can only happen if the values of P, A, and Bare known for all LINK or if they have access to the servers that communicate with the LINK. These are only available in a distributed network, and only client servers can communicate with LINK servers.

### The Key Verification Process:

Iteratively the value Kₙ and Eₙ are provided to the ID set from last to the first.
Kₙ=IDKEY.
Eₙ=1.

LINK in turn evaluates the value Kn−1. If the remainder R is zero, then it returns the given value Kn−1 and En−1. Otherwise, it returns the new value Kₙ and Eₙ,

$$Kn - 1 = ( {K}_{n} xor {C}_{n} ) / {P}_{n} + R \\ En - 1 = {E}_{n} \times {C}_{n} + {D}_{n}$$

When all seven members of Nid return their evaluation, the final value E_{final} is the key that decrypts the cloud data of a given SQid.

The user data kept in the cloud are then hashed and checked against the hashed portion of SQid. A match will verify the authenticity of the key.

### Proof of Entanglement (PoE):

The PoE process is much like the ID verification process. However, what is unique about PoE is the relationship that exists between any two given SQids. This relationship is used to create an entanglement key whereby the sender can encrypt the document, and it can only be decrypted by the receiver. The SQid verification process guarantees that only the true SQid can access the specific data stored in LINK devices in order to reproduce the exact entanglement key. Furthermore, the following relationship calculates the entropy of the shared key. Due to the random nature of parameters P, A, B, C, and D, Shor's algorithm-used by quantum computers-cannot be used in attempted decryption. For this reason, PoE is a quantum-proof algorithm.
ID={1, 2, 3, . . . 79}
Set of first 79 integers.
Vid1 unique subset of {72, 79}
A unique subset of LINK IDs. Belonging to SQid1
Vid2 unique subset of {72, 79}
A unique subset of LINK IDs. Belonging to SQid2
Uid intersect {Vid1, Vid2} The intersection of sets Vid1 and Vid2.

$$Eid = ID - Uid$$

The set that does not include Uid.

Depending on Vid1 and Vid2, Eid has 7 to 14 members. The client server representing SQid1 has access to its own SQid and the SQid of the receiver. With these two user IDs, the client-server can receive Vid1 and Vid2 via the ID verification process, through link servers. It then uses the Eid set and the following relationships to calculate the encryption key that links these two SQids.

$$\begin{matrix}Key Calculation & Key Size Calculation \\ Ko = 1 & e 0 = 0 \\ K 1 = ( P 1 \times Ko + A 1 ) xor {B}_{1} & e 1 = ( {2}^{**} 16 ) * ( {2}^{**} 16 ) = ( {2}^{**} 32 ) \\ K 2 = ( P 2 \times K 1 + A 2 ) xor {B}_{2} & \begin{matrix}e 2 = e 1 + ( {2}^{**} 16 ) * ( {2}^{**} 16 ) = ( {2}^{**} 32 ) + \\ ( {2}^{**} 17 )\end{matrix}\end{matrix}$$

### Continue for all Members of Eid.

$${K}_{n} = ( {P}_{N} \times {K}_{n - 1 +} {A}_{n} ) xor {B}_{n} \\ {e}_{n} = {e}_{n - 1 +} {2}^{( n + 1 ) * 17}$$

for n>1

The subscript n has a min value of 7 and a max value of 14. The key size is the average of individual key sizes:

| | |
|---|---|
| e₇ = 32 + 6 * 17 | =134 |
| e₈ = 32 + 7*17 | =151 |
| e₉ = 32 + 8 * 17 | =168 |
| e₁₀ = 32 + 9 * 17 | =185 |
| e₁₁ = 32 + 10 * 17 | =202 |
| e₁₂ = 32 + 11 *17 | =219 |
| e₁₃ = 32 + 12 * 17 | =236 |
| e₁₄ = 32 + 13 * 17 | =253 |

$$E = ( e 7 + e 8 + e 9 + e 10 + e 11 + e 12 + e 13 + e 14 ) / 7. \\ E = ( 134 + 151 + 168 + 185 + 202 + 219 + 236 + 253 ) / 7$$

Therefore, the size of the PoE encryption key is 185 bits. It will be strategically padded to 256 bits. Any symmetric encryption algorithm such as AES-256 may be used to encrypt and decrypt the document being sent from the sender to the receiver.

### Sample Transaction:

1. What is being claimed as shown in FIG. 2, Table 1, and described in sections 10, 11, and 12 in the platform description, is that it is possible to create a public user ID that can carry its own verification, and the verification key can be used to securely decrypt the content of the user information.

2. Using PoE as described in section 13, a transaction can be encrypted in one server and sent to another remote server without a direct connection, so the PoE mechanism indirectly provides the encryption key to both parties.

3. In claim 1, the public ID (SQid) contains cryptographic information about its owner.

4. In claim 1, the public ID (SQid) may or may not contain secure information about the location and address of data in databases and/or blockchains.

5. In claim 1, the public ID (SQid) may be independently secured as a QR code and scanned by third-party software.

6. In claim 5, the ability to independently secure the public ID (SQid) as a QR code and scan it with third-party software ensures convenient and reliable verification processes.

7. In claim 1, the public ID (SQid) can be used as a secure authentication mechanism for various physical and digital assets.

8. In claim 1, SQid may be used to identify inanimate objects.

9. In claim 1, SQid may contain information that describes the type of data or object being referred to.

10. In claim 2, Proof of Entanglement can be used as a bilateral secure link between two endpoints, and this cryptographic link removes the need for Diffie-Hellman or any other type of key exchange.

11. In claim 2, Proof of Entanglement can be used as a bilateral link between people and inanimate objects.

12. In claim 2, the shared key is not detectable or calculated by any one party, and it is generated by the platform at the time of usage and destroyed after usage is completed.

13. In claim 2, the cryptographical shared key is not calculatable by shore's algorithm since it is not cyclic by design.

14. In claim 2, the shared key generated by PoE may be recorded in a database or a blockchain with the approval of both parties only.

15. In claim 2, the generated shared key is secured against all present methods of cryptographical discoveries due to the sheer size of the key in term of its entropy, and the complexity of the generated key is 2 to power 234 bits or 10e70.
